(19) United States
(12) Patent Application Publication
(10) Pub. No.: US 2011/0220469 A1
(43) Pub. Date: Sep. 15, 2011

(54) USER CONFIGURABLE SWITCH ASSEMBLY

(76) Inventors: Randy Michael Freiburger, Novi, MI (US); Boris Smith, Belleville, MI (US)

(21) Appl. No.: 12/815,495

(22) Filed: Jun. 15, 2010

Related U.S. Application Data
(60) Provisional application No. 61/313,498, filed on Mar. 12, 2010.

(51) Int. Cl. H01H 9/00

(52) U.S. Cl. 200/61.54

(57) ABSTRACT

A switch assembly having steering wheel switches located on the steering wheel and are configured to provide generic outputs enabling the connection of equipment controlled from the steering wheel. Specialty vehicles may be up-fit with equipment to perform varying functions defined by the needs of the individual user using the vehicle. Users can define functions critical to their specific usage that enable maintaining both hands on steering wheel while performing mission-critical functions and reduce driver distraction from verifying that a switch, button, or dial on a control head is in the desired position.

### CROSS-REFERENCE TO RELATED APPLICATION

This application claims the benefit of U.S. Provisional Application No. 61/313,498, filed Mar. 12, 2010, entitled “USER CONFIGURABLE. STEERING WHEEL CONTROLS,” the entire disclosure of which is incorporated herein by reference.

### FIELD OF THE INVENTION

The present invention generally relates to vehicle user controls, and more particularly relates to switch assemblies that provide outputs configurable by user defined functions (e.g., lights, sirens, radio, etc.).

### BACKGROUND OF THE INVENTION

It is common practice in the automotive industry to supply vehicles for use by commercial businesses, emergency response agencies, and/or law enforcement agencies by modifying passenger vehicles that are produced for more general, non-commercial use. Examples of necessary modifications for such specialty users often include lights, sirens, radios, public address systems, radar systems, video recording/transmitting systems, license plate recognition systems, communication systems, location position systems. For example, a police vehicle will typically employ emergency lighting mounted externally at various locations on the vehicle. Some police vehicles may have video recording/transmitting equipment that records/transmits activity while addressing a traffic violation and some law enforcement agencies often will implement a two-way radio.

As sold to the end-user or upfitter, the vehicle may include control heads for the individual pieces of equipment. Conventionally, these control heads were typically mounted between the seats in a floor mounted console which serves as the point of control for that piece of equipment. Operation of these types of equipment has traditionally been accomplished manually on control heads conventionally mounted in floor consoles between the driver and passenger seats. This manual operation, many times, requires visual verification at the control head to confirm the desired switch position, button, and/or dial has been placed in the desired position. Traffic conditions, in the direction of vehicle travel, can change in the time driver's eyes are removed from the direction of travel and create a driver distraction.

### SUMMARY OF THE INVENTION

According to one aspect of the present invention, a user control switch assembly for a vehicle is provided. The switch assembly includes at least one switch having a switch output indicative of an actuated position of the switch. The switch assembly also includes an output terminal for electrically connecting a device to be controlled to the vehicle. The switch assembly further includes switch translation circuitry receiving the switch output and translating the switch output to control the device connected to the output terminal based on the actuated switch position.

According to another aspect of the present invention, a user control switch assembly for a steering wheel on a vehicle is provided. The switch assembly includes at least one switch located on a steering wheel in a vehicle and having a switch output indicative of an actuated position of the switch. The switch assembly also includes an output terminal for electrically connecting one or more devices to be controlled to the vehicle. The switch assembly further includes switch translation circuitry receiving the switch output and translating the switch output to control the one or more devices based on the actuated switch position.

These and other aspects, objects, and features of the present invention will be understood and appreciated by those skilled in the art upon studying the following specification, claims, and appended drawings.

### BRIEF DESCRIPTION OF DRAWINGS

In the drawings:

FIG. 1 is a front view of a steering assembly in a vehicle employing user controls for a specialty (e.g., police program) vehicle, according to one embodiment;

FIG. 2 is a front view of a steering assembly in a vehicle employing user controls, according to another embodiment;

FIG. 3 is a schematic design of the steering wheel control switches using a resistive ladder network providing a grounded output through the translator module, according to a first embodiment;

FIG. 4 is a schematic design of the steering wheel control switches of FIG. 3 providing a five volt output through the translator module;

FIG. 5 is a schematic design of the steering wheel control switches of FIG. 3 providing a twelve volt output through the translator module;

FIG. 6 is a schematic design of the steering wheel control switches that send messages over the CAN bus communication structure providing a grounded output through the translator module, according to a second embodiment;

FIG. 7 is a schematic design of the steering wheel control switches of FIG. 6 providing a five volt output through the translator module;

FIG. 8 is a schematic design of the steering wheel control switches of FIG. 6 providing a twelve volt output through the translator module;

FIG. 9 is a block diagram further illustrating the translation module and indicator lights, according to one embodiment;

FIG. 10 is a flow diagram illustrating the switch command processing routine shown in FIG. 9, according to one embodiment;

FIG. 11 is a flow diagram illustrating a user defined function routine for performing user defined vehicle function(s), according to one embodiment; and

FIG. 12 is a block diagram illustrating the use of a mode switch to control configured functions, according to a fourth embodiment.

### DETAILED DESCRIPTION OF PREFERRED EMBODIMENTS

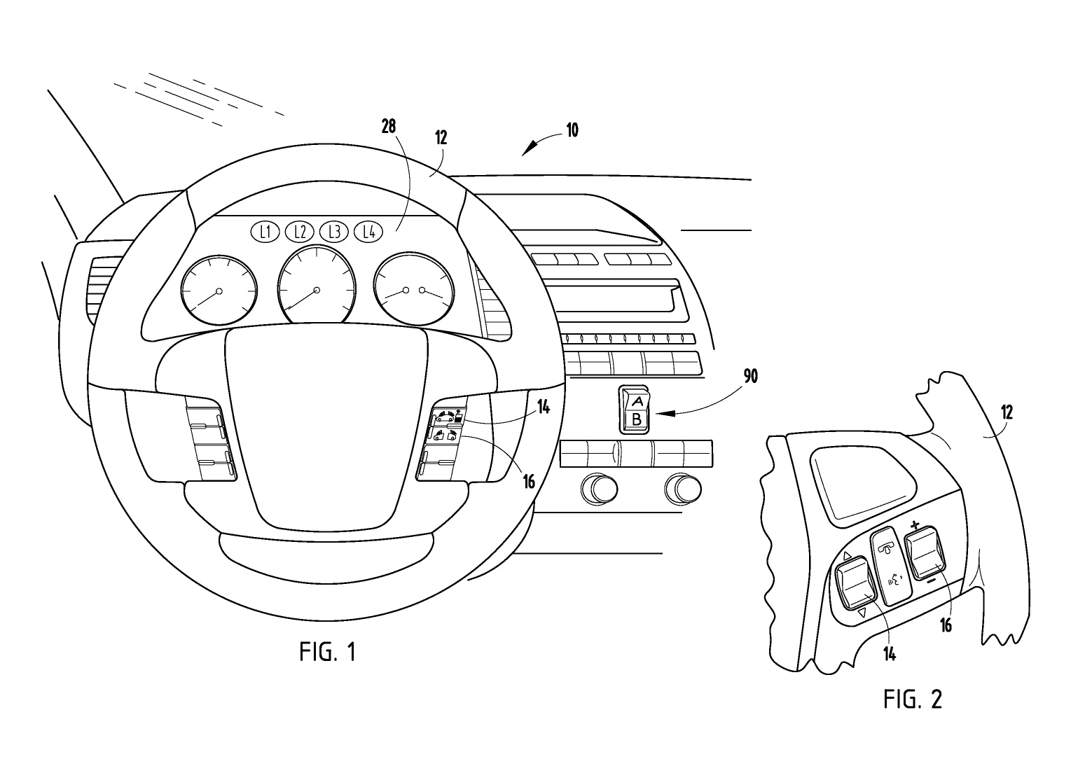

Referring to FIGS. 1 and 2, an automotive vehicle 10 is generally illustrated having a steering wheel 12 conventionally arranged forward of the driver's seat in the passenger cockpit such that the steering wheel and switch assembly controls located thereon are actuatable by the driver of the vehicle 10. The steering wheel 12 is part of the steering assembly that is actuatable by the driver to steer the direction of the vehicle 10. The vehicle 10 may include a passenger car, van, truck or other vehicle that employs a steering wheel and user actuatable control switches which make the vehicle a specialty vehicle. In the embodiment shown, the vehicle 10 is configured as an emergency response vehicle such as the type that may be employed by law enforcement agencies such as police, medical response and rescue personnel such as in an ambulance, and other vehicles. The vehicle 10 may be referred to as a specialty vehicle that may include emergency response vehicles and commercial vehicles.

The steering wheel 12 is shown having a switch assembly including various user actuatable switches provided thereon which may be actuatable by a user, such as the driver of the vehicle 10. These switches include first and second configurable switches 14 and 16 which are depressible on either the left side or the right side of the respective switches in FIG. 1 or are depressible upward on the top side or downward on the bottom side in FIG. 2. The switches 14 and 16 each latch or unlatch in two positions and in total provide user selectable control of four functions, according to one embodiment shown and described herein. An additional switch, referred to as a mode control switch 90, is shown installed on the vehicle dash and is actuatable by a user to select one of a plurality of operating modes (A and B) of the switch assembly so that one or more of the switches 14 and 16 may offer additional functions, according to one embodiment. Mode control switch 90 may be located on the steering wheel or in another user accessible location according to other embodiments. It should be appreciated that the switch assembly may employ one or more configurable switches on the steering wheel 12 to provide control of one or more functions.

The vehicle 10 is also shown in FIG. 1 equipped with a plurality of light indicators L1-L4 located in the instrument panel or cluster 28 in plain view by the driver of the vehicle 10. The light indicators L1-L4 provide on or off or flashing light outputs indicative of the on or off status of switches 14 and 16 and the two switch positions, respectively. The light indicators L1-L4 may be controlled to flash at a predetermined flashing rate to further indicate a normal or malfunction status of the switch 14 and 16 based on switch diagnostics.

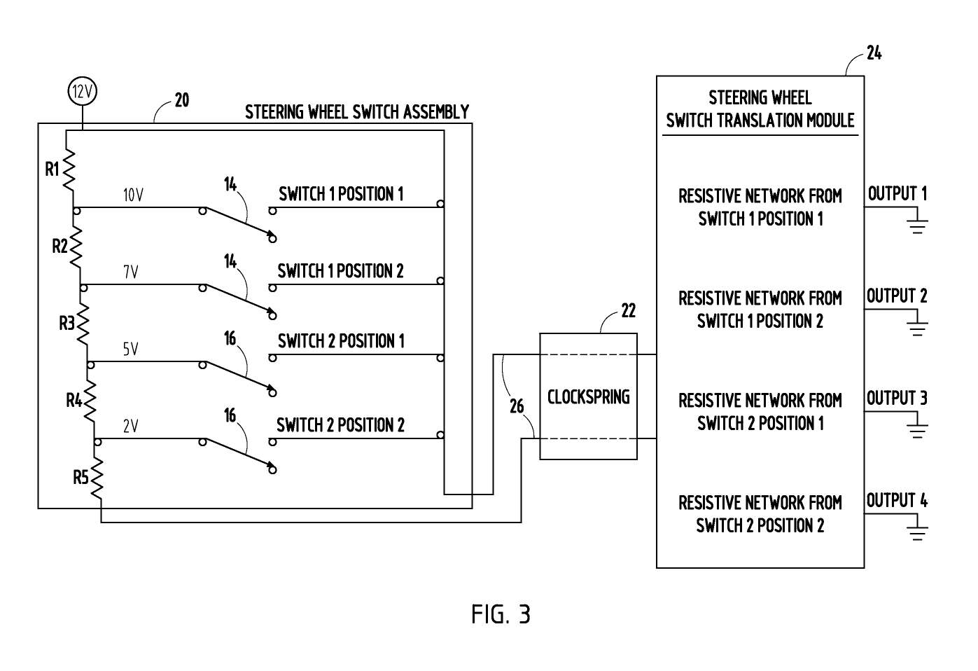

Referring to FIGS. 3-5, steering wheel mounted switches 14 and 16 are illustrated as part of a steering wheel switch assembly 20, according to one embodiment. The switch assembly 20 has a resistive ladder network including five series connected resistors R1-R5 acting as voltage dividers. A voltage supply, such as twelve volts (12 v), from the vehicle battery is applied to resistor R1. Switches 14 and 16 each have first and second switch positions which are shown tied into the resistive network at certain locations such that closure of the corresponding switch in a designated position generates a unique voltage for each switch in its first switch position or second switch position. For example, first switch 14 in its first switch position when closed generates a ten volt (10 v) output, whereas switch 14 when closed in its second switch position generates a seven volt (7 v) output, and second switch 16 when closed in its first position generates a five volt (5 v) output, and switch 16 when closed in its second position generates a two volt (2 v) output. This is achieved by dividing the twelve volt supply by the drop in voltage across the individual resistors R1-R5 of the resistive ladder network.

The voltage outputs from the switch assembly 20 pass through wires or a bus 26 passing through the clockspring 22 of the steering wheel assembly and are input to a steering wheel switch translation module 24. The translation module 24 includes processing circuitry to process and translate the voltage output received from the switch assembly 20 and determine which of outputs 1-4 to activate based on the received voltage which is unique to a certain switch position. Since there are two switches, each having two positions in the embodiment shown, four outputs may be enabled for four functions that may be defined and configured by an end user. Pushing one of the switches 14 or 16 into one designated switch position a first time will latch the circuit to enable turning on the defined function, which may include, for example, turning on lights, sirens, radio, etc. The function designated by the output may be turned off by pushing the same switch into the same position for a second time, according to one embodiment. The translation module 24 may generate the outputs 1-4 by providing a grounded connection to allow electrical current to pass through the output to a device configured therewith, according to one embodiment.

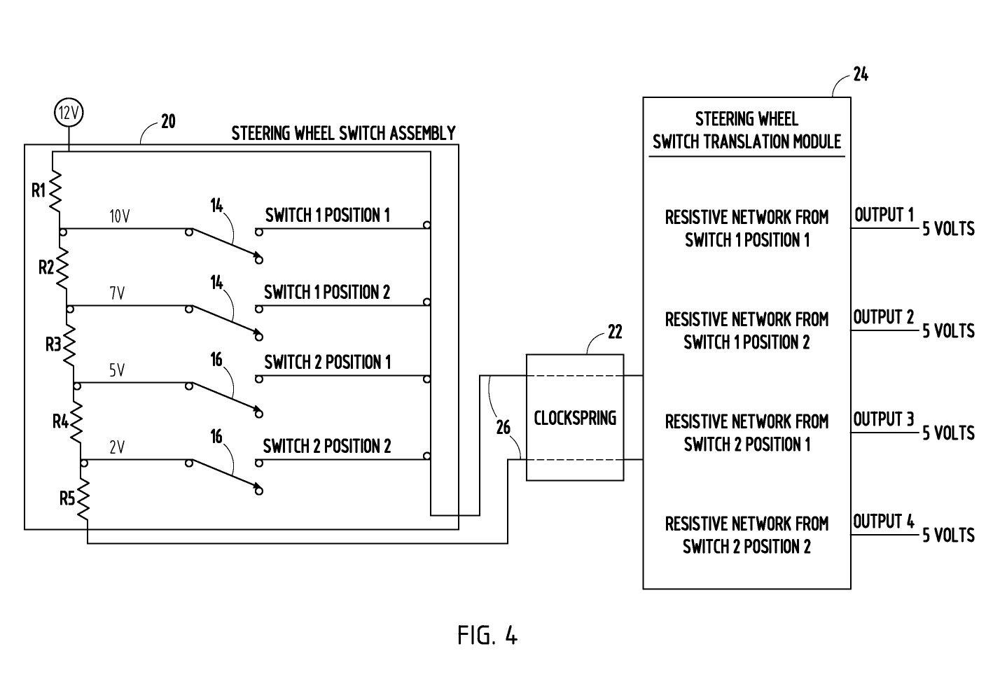

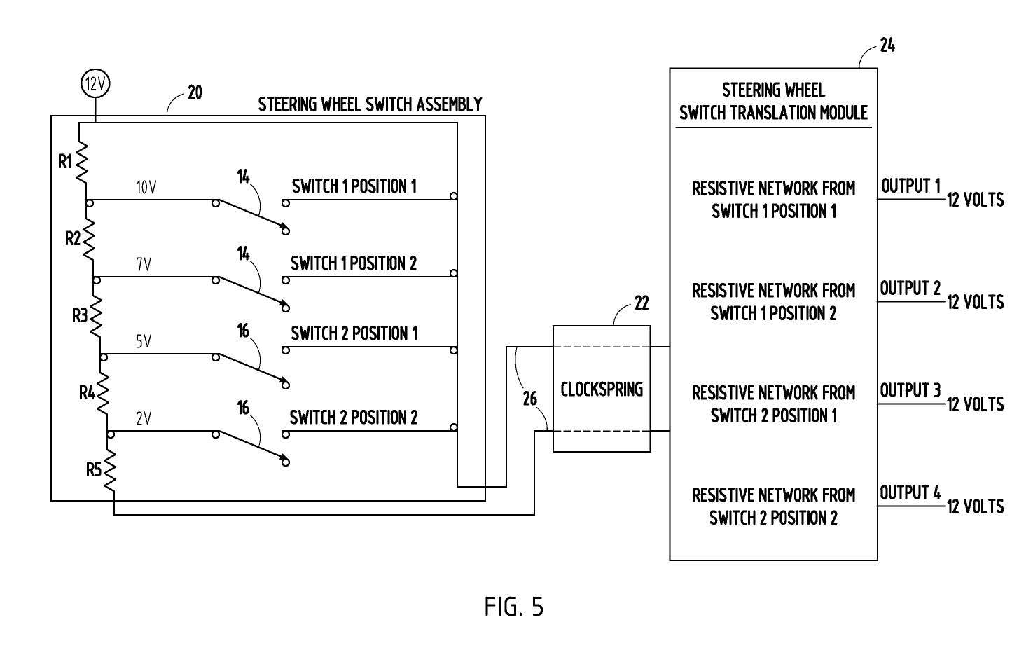

As seen in FIG. 3, a resistive ladder switch network is employed for switches 14 and 16 at the steering wheel that provides a voltage signal for each switch position actuated, and the voltage signal is sent to the translation module 24. This voltage signal is received by the translation module 24 and translated to determine the switch 14 or 16 that is depressed and its position and provides a grounded output to which the equipment or device configured by the user to perform one or more desired functions. Further, as seen in FIGS. 4 and 5, the resistive ladder switch network is employed for switches at the steering wheel that provides voltages which are sent to the translator module 24. This voltage signal(s) received by the translator module 24 determines the switch 14 or 16 that is depressed and its position and provides grounded outputs in FIG. 3, five volt outputs in FIG. 4 or twelve volt outputs in FIG. 5, respectively. Thus, the translation module 24 may provide grounded, five volt outputs, twelve volt outputs or other desired voltage or currents as outputs to power desired equipment that may be installed by a user or its upfitter.

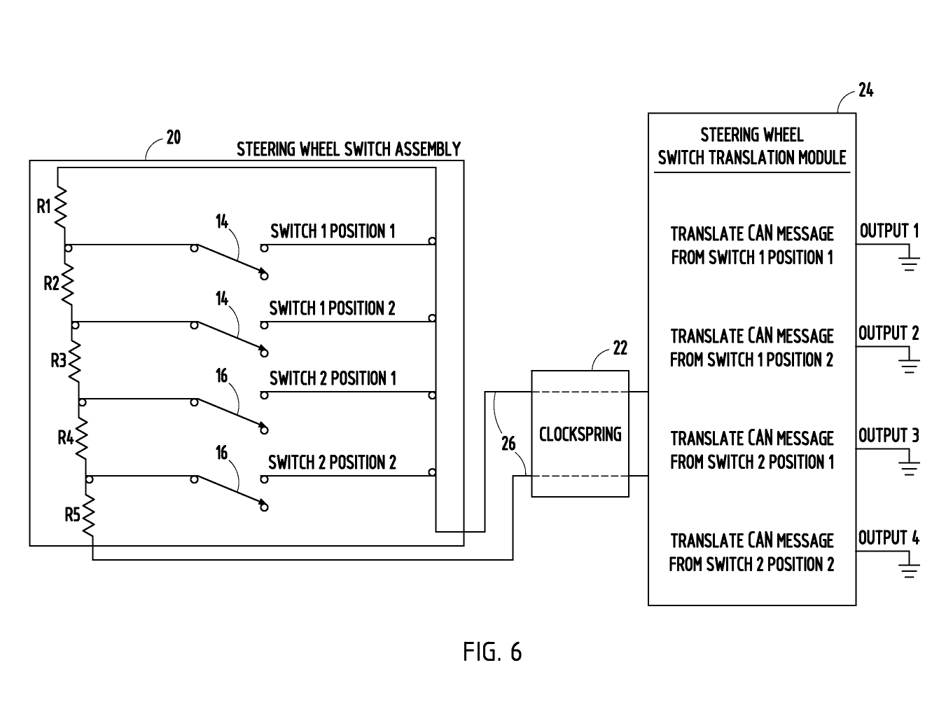

Referring to FIGS. 6-8, a user actuatable switch assembly is illustrated employing a Controller Area Network (CAN) signal communication bus 26, according to another embodiment. In this embodiment, the switch assembly 20 includes switches 14 and 16 each user actuated by depressing into first or second positions a first time to generate an output that passes through the clockspring 22 to the translation module 24. In this embodiment, the switches 14 and 16 generate messages in the form of alphanumeric code signals which are transmitted through the clockspring 22 to the translation module 24 by way of a CAN communication bus 26. The alphanumeric code message is indicative of the switch and its position activated by a user. The translation module 24 reads the output code from the switch assembly 20 and determines which switch and the switch position that was activated, translates the message, and provides a controlled output signal on outputs 1-4. By activating one or more outputs, one or more functions designated for each output may be activated. To turn the output function off, a user may activate the same switch and switch position a second time, according to one embodiment.

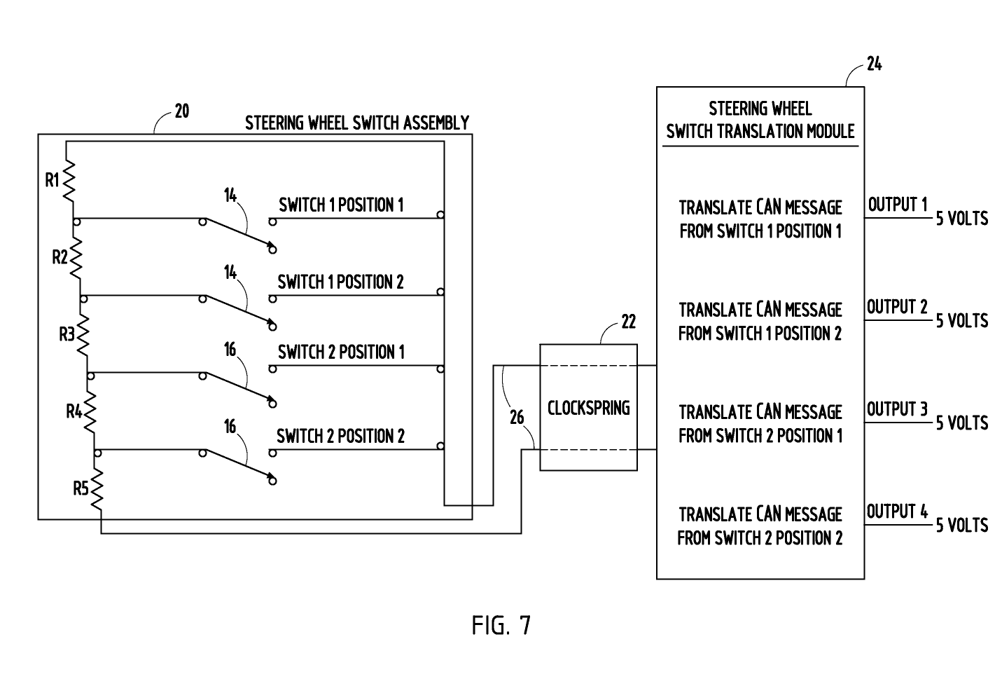

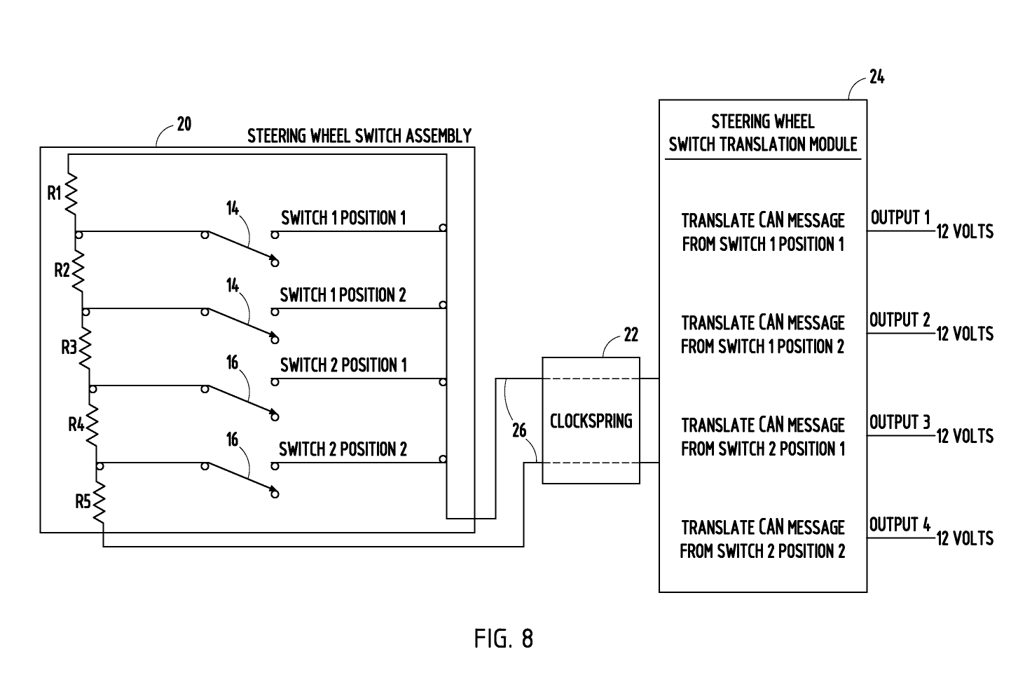

As seen in FIG. 6, the steering wheel switch 14 or 16 provides a CAN bus message when actuated that is read by the translation module 24 that determines which switch is depressed and its switch position and provides a grounded output at the corresponding output to which the equipment identified by the user or its upfitter is connected to perform a function. As further seen in FIGS. 7 and 8, each steering wheel switch when actuated in either the first or second position provides a CAN message that is read by the translation module 24 to determine which switch is depressed and its switch position and provides grounded outputs in FIG. 6, five volt outputs in FIG. 7, and twelve volt outputs in FIG. 8, respectively, which are output to power the equipment configured by the user or its upfitter to perform one or more functions.

A conventional automobile produced by an original equipment manufacturer (OEM) for use by the general public generally does not include steering wheel control switches that are configurable by the customer, user or upfitter to function or control equipment. Specialty vehicles, such as law enforcement agencies, emergency response vehicles and commercial vehicles, typically have requirements for unique equipment based on their intended use. Since the needs of the users of specialty vehicles vary greatly, it is generally not practical for an OEM to produce vehicles that are fully equipped and ready to enter service. In such cases, the OEM may provide a vehicle directly to the end-user for modification/customization. It is also common for the end-user to contract with an intermediary company that specializes in modification of vehicles, commonly known as an upfitter. The term “user” means an end user (e.g., consumer) or the upfitter that configures the switch assembly for the user. For example, an upfitter may, under contract to a law enforcement agency (LEA), install a suite of equipment specified by the LEA. Such equipment may include lights, sirens, 2-way radios, speed monitoring, video cameras/recorders, or the like. Location of critical functions, as defined by the LEA, based on specific use of the vehicle will enable maintaining both hands on the steering wheel and reduce driver distraction associated with visual verification that the switch, button, or dial is in the desired position.

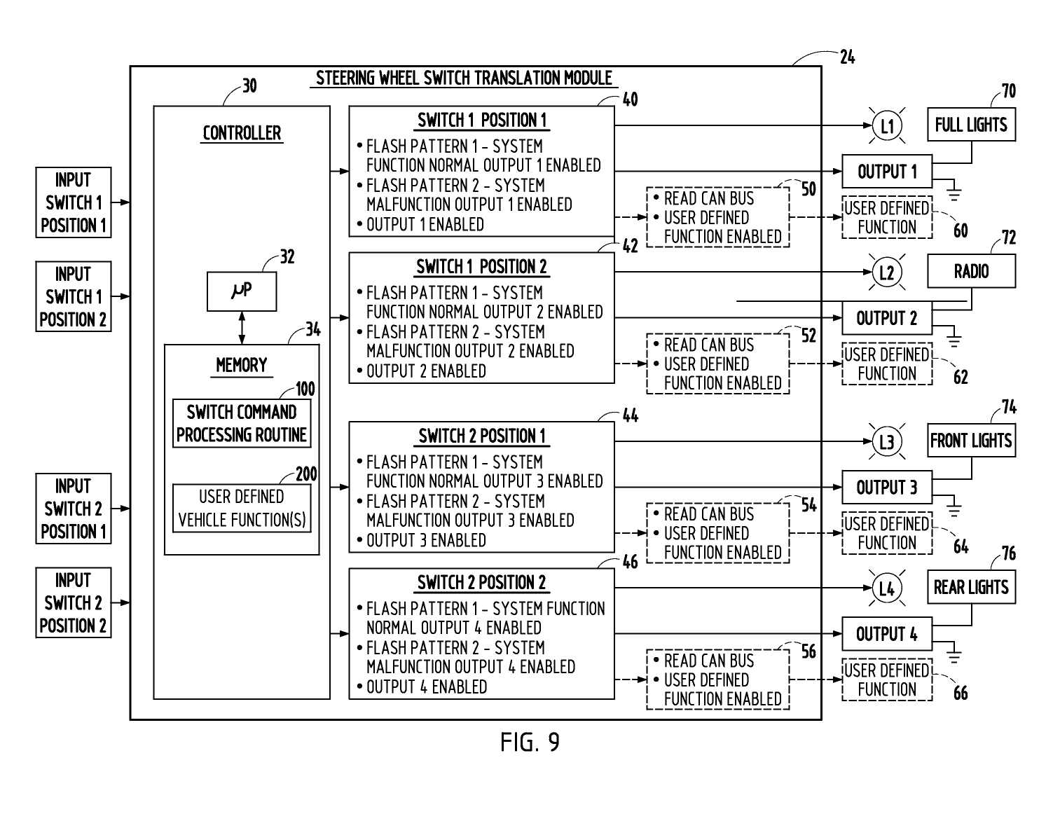

The translation module 24 is illustrated in FIG. 9, according to one embodiment. In this embodiment, the translation module 24 includes control circuitry, shown as a controller 30 having a microprocessor 32 and memory 34. The controller 30 may otherwise be configured to include other analog and/or digital circuitry for processing and storing various routines and data. Memory 34 may include random access memory (RAM), read-only memory (ROM), electronically erasable programmable read-only memory (EEPROM), or other known electronic storage medium. Stored within memory 34 and executable by microprocessor 32 is a switch command processing routine 100 and one or more user defined vehicle functions 200.

The controller 30 has inputs that receive input signals from the switches 14 and 16 indicative of actuated switch positions. The controller 30 processes the input signals to acquire switch information by executing the switch command processing routine 100 and any user defined vehicle functions 200. The translation may include translating the switch information in the form of a voltage, in the voltage embodiment, by comparing the voltage output from a switch to predetermined voltages and enabling an output that corresponds to the voltage assigned to a switch in the corresponding switch position. The translation may include, in the CAN bus communication embodiment, comparing alphanumeric characters to predetermined alphanumeric characters indicative of a switch and its position and enabling an output that corresponds to the switch in its position based on the comparison. The controller 30 provides outputs to control one or more devices based on the actuated switch positions.

The translation module 24 is shown having the four outputs, output 1-4, coupled to various user or upfitter installed devices. According to one embodiment, output 1 is coupled to a full set of lights 70 which may serve as a siren. Output 2 is shown coupled to a radio 72, such as a police radio. Output 3 is shown connected to the front lights 74 such that front lights, such as sirens, on the front of the vehicle are illuminated separate from the rear lights. Output 4 is shown connected to the rear lights 76 such that the rear lights, such as a siren, on the rear of the vehicle is illuminated independent of the front lights. According to another embodiment, one of outputs 1-4 may be configured to turn off the flashing lights on one side of an emergency vehicle, such as the right side of a police vehicle, while maintaining lights on the opposite side of the vehicle, such as a left side of the vehicle which typically may be exposed to traffic. The function of turning off the right side lights and maintaining the left side lights on enables a police officer for a police vehicle to conduct business with reduced lighting on one side of the vehicle while maintaining flashing alert lights on the opposite side during a vehicle stop. It should be appreciated that various other devices such as roof mounted sirens, public address systems, radar systems, video recording/transmitting systems, license plate recognition systems, communication systems, location position systems and other systems and devices may be connected to the outputs by an end user or its upfitter depending on the needs of the specialty vehicle, according to other embodiments.

The translation module 24 is also shown coupled to a set of indicator lights L1-L4 which serve as indicators to indicate which switch and switch position is turned on and serve as a diagnostic indicator to indicate the normal or malfunction status of the switch and its switch position. The indicator lights L1-L4 are shown in FIG. 1 installed in the instrument panel or cluster 28 in a region generally forward of the steering wheel 12 and viewable by the driver of the vehicle 10. The indicator lights L1-L4 may include one or more LEDs or other lighting devices which may be turned on or off in one or more colors and may be flashed in predetermined patterns indicative of a status indication.

The translation module 24 is shown in FIG. 9 providing various functions when each of the switches is actuated in corresponding switch positions, as shown in blocks 40, 42, 44 and 46. When switch 1 position 1 is actuated in logic block 40, logic 40 flashes the indicator light L1 in a flash pattern 1 to indicate that the system function normal output 1 is enabled, or flashes a flash pattern 2 indicative of a system malfunction output 1 enabled, when the output 1 is enabled. Similarly, when switch 1 position 2 is actuated, logic 42 flashes indicator light L2 at flash pattern 1 when the system function of output 2 is enabled and flashes a flash pattern 2 when the system malfunction output 2 is enabled. In logic block 44, when switch 2 position 1 is actuated, the indicator light L3 will flash at the flash pattern 1 when the system function normal output 3 is enabled, and will flash at a flash pattern 2 when the system malfunction output 3 is enabled, when output 3 is enabled. In logic 46, when switch 2 position 2 is actuated, indicator light L4 flashes at a flash pattern 1 when the system function normal output 4 is enabled, and flashes as a flash pattern 2 when the system malfunction output 4 is enabled, when the output 4 is enabled. It should be appreciated that the controller 30 provides the function of logic blocks 40, 42, 44 and 46 to enable each of the outputs 1-4 and controls the indicator lights L1-L4 and their flashing sequence, and further provides user defined functions as explained herein.

The user defined vehicle functions 200 are made available to allow a user to define certain added functions that occur when one or more of the switches are activated. As seen by logic block 50, the CAN bus can be read and the user defined function(s) can be enabled so as to provide a user defined function output 60 which relates to the output 1 when switch 1 is actuated in position 1. Similarly, logic block 52 reads the CAN bus and provides a user defined function enabled to generate a user defined function output 62 related to output 2 when switch 1 is actuated in position 2. Logic block 54 reads the CAN bus and enables the user defined function to provide a user defined function output 64 related to output 3 when switch 2 is actuated in position 1. Finally, logic block 56 reads the CAN bus and enables the user defined function to provide the user defined function output 66 related to output 4 when switch 2 is actuated in position 2.

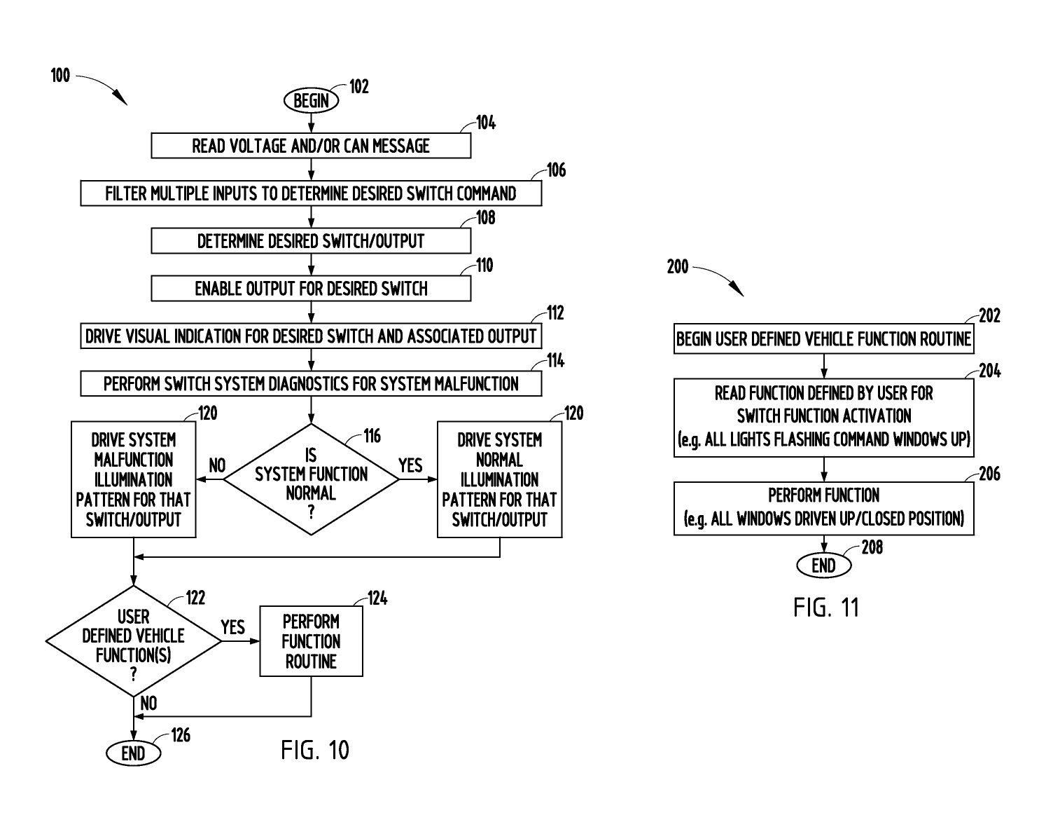

Referring to FIG. 10, the switch command processing routine 100 is illustrated according to one embodiment. Routine 100 begins at step 102 and proceeds to step 104 to read the voltage and/or CAN message obtained from the CAN bus. In the voltage based embodiment, the voltage signal received from a switch is read which is indicative of which switch and the switch position that is actuated. In the CAN message based embodiment, the message received is read and used to determine which switch and the position that has been actuated. At step 106, routine 100 filters the multiple inputs to determine the desired switch command This may be achieved by comparing the voltage signal generated by the resistive network in the voltage embodiment to predetermined voltages or voltage ranges so as to determine which switch and position corresponds to the voltage signal. Alternately, in the CAN message embodiment, the message is compared to predetermined messages to determine which switch and position has been actuated. The determined desired switch output is then determined at step 108. At step 110, routine 100 enables the output for the activated switch and switch position such that output 1 is enabled when switch 1 position 1 is actuated, output 2 is enabled when switch 1 position 2 is actuated, output 3 is enabled when switch 2 position 1 is actuated, and output 4 is enabled when switch 2 position 2 is actuated, according to one embodiment.

Once the output for the corresponding switch and switch position has been enabled, routine 100 proceeds to step 112 to drive the visual indication for the desired switch and its associated output. Next, at step 114, routine 100 performs switch system diagnostics to determine the presence of a system malfunction. Routine 100 thereby determines whether or not the switch assembly or system is operating properly or is experiencing a malfunction. Decision block 116 determines if the system function is normal and, if so, drives the system normal illumination pattern to illuminate the light indicator for the corresponding switch/output state at step 120. If the system function is not normal, indicative of a malfunction, routine 100 proceeds to step 120 to drive the system malfunction illumination pattern for the corresponding light indicator that corresponds to the switch/output state.

Following the system diagnostics and light indicators steps, routine 100 proceeds to decision step 122 to determine if there are any user defined vehicle functions. It should be appreciated that one or more user defined vehicle functions may be provided by an upfitter or end user of the vehicle to perform specified functions when a switch is activated, in addition to controlling the output that corresponds to the switch and a given switch position. If one or more user defined vehicle functions are present, routine 100 proceeds to step 124 to perform the specified function routine, before ending at step 126. It should be appreciated that the function routine may be specified by the user or upfitter to perform any of a number of functions, such as automatically closing vehicle windows when the vehicle siren is turned on.

Referring to FIG. 11, one example of a user defined function routine 200 is illustrated. Routine 200 begins at step 202 and proceeds to step 204 to read the function defined by the user for the switch position activation. According to one example, an all lights flashing command initiated by actuation of switch 1 position 1 to turn on the full set of lights may cause all powered vehicle windows to be driven up to the closed position. This may be desirable for emergency personnel when they turn on their lights or sirens to have the windows automatically close without requiring separate user intervention or actuation of the windows. Once the function is read in step 204, routine 200 performs the function by driving the windows up to the closed position in step 206, before ending at step 208. It should be appreciated that various other user defined functions may be implemented by the translation module based on functions that are defined by either the manufacturer of the vehicle or the upfitter or a user, according to the needs of the user.

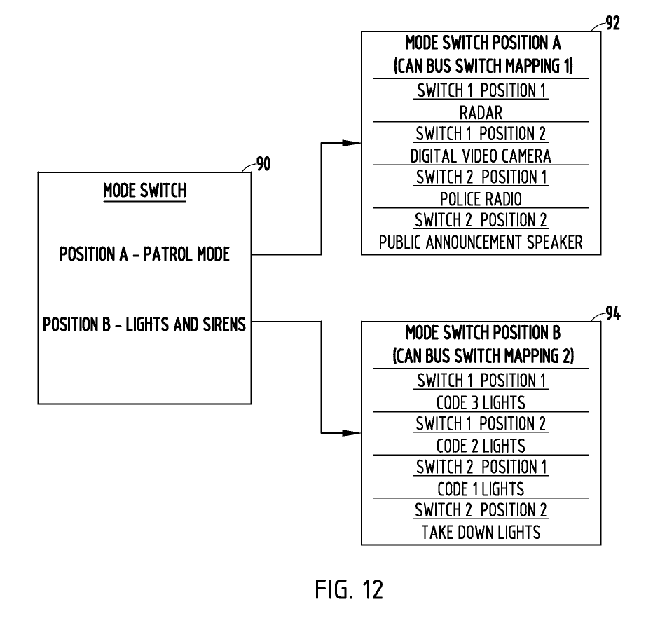

Referring to FIG. 12, the switch assembly is shown implement with the mode control switch 90, according to another embodiment. In this embodiment, the mode control switch 90 is a separate switch located on the vehicle 10, such as on the dash or on the steering wheel or at another location that is within reach of the user, to control a plurality of modes of the switch assembly. The mode control switch 90 has a first position A, which in one example is designated as a patrol mode, and a second position B, which in this example is designated as lights and siren. With the mode control switch 90 actuated in the first position A patrol mode, mode A operates the CAN bus switch mapping in a first mode in which the switches and switch positions operate a first set of allocated functions which may include those mode A functions shown in block 92. While operating in mode A, switch 1 position 1 (S1, P1) controls the radar, switch 1 position 2 (S1, P2) controls the digital video camera, switch 2 position 1 (S2, P1) controls the police radio, and switch 2 position 2 (S2, P2) controls the public announcement speaker. In contrast, when the mode control switch 90 is actuated in position B, mode B labeled lights and siren, provides functions in the CAN bus switch mapping 2 mode shown in block 94. While operation in mode B, switch 1 position 1 (S1, P1) controls the code 3 lights which include all lights on, switch 1 position 2 (S1, P2) controls the code 2 lights which include all rear lights, switch 2 position 1 (S2, P1) controls the code 1 lights which include the front lights, and the switch 2 position 2 (S2, P2) controls the takedown lights which typically include the center lights on the light bar of an emergency vehicle. Accordingly, the mode control switch 90 allows a user to select two different modes of the switch assembly such that additional functionality may be achieved with the switches by designating a desired mode of operation. It should further be appreciated that the mode control switch 90 may include more than two positions, such that additional functions may be controlled with the switch assembly.

Accordingly, a vehicle 10 can be configured with one or more switches assembled to the vehicle steering wheel 12 that may be configured to perform various functions. For example, outputs from the translation module 24 may be coupled to one or more devices which may then be controlled by the steering wheel assembly switches. For specialty vehicles, such as emergency response vehicles including police cars, the outputs may be connected to one or more emergency lights, sirens, 2-way radios, public address speaker, speed monitoring, video cameras/recorders, and other devices that may provide mission critical functions. It should be appreciated that these and devices may be connected by a user or an upfitter to meet the needs of the user.

It is to be understood that variations and modifications can be made on the aforementioned structure without departing from the concepts of the present invention, and further it is to be understood that such concepts are intended to be covered by the following claims unless these claims by their language expressly state otherwise.

We claim:

1. A user control switch assembly for a vehicle, said switch assembly comprising:
at least one switch having a switch output indicative of an actuated position of the switch;
an output terminal for electrically connecting a device to be controlled to the vehicle; and
switch translation circuitry receiving the switch output and translating the switch output to control the device connected to the output terminal based on the actuated switch position.

2. The switch assembly as defined in claim 1, wherein the at least one switch is mounted on a steering wheel of the vehicle.

3. The switch assembly as defined in claim 1, wherein the switch assembly is configurable by an upfitter to outfit the vehicle for a user as a specialty vehicle.

4. The switch assembly as defined in claim 3, wherein the at least one switch controls lights on an emergency vehicle.

5. The switch assembly as defined in claim 1, wherein the translation circuitry performs a diagnostic routine to determine whether the switch is working properly and, if not, provides an output indicator.

6. The switch assembly as defined in claim 1, wherein the controls further comprise one or more indicator lights for indicating the status of the at least one switch.

7. The switch assembly as defined in claim 1 further comprising a resistive network coupled to the at least one switch for generating a voltage indicative of the actuated position of the switch, wherein the switch translation circuitry translates the switch output voltage to determine the actuated switch position based on the voltage.

8. The switch assembly as defined in claim 1, wherein the switch translation circuitry translates the switch output to determine the actuated switch position based on a communication message.

9. The switch assembly as defined in claim 1, wherein the switch translation circuitry determines if the switch has been actuated and provides a grounded output to the output terminal to control the device.

10. The switch assembly as defined in claim 1, wherein the switch translation circuitry determines if the switch has been actuated and provides a voltage output to control the device.

11. The switch assembly as defined in claim 1, wherein the at least one switch comprises a plurality of switches, each switch having at least one actuatable position, wherein the translation circuitry translates the switch output to control at least one of a plurality of devices based on the determined actuated position of a switch.

12. A user control switch assembly for a steering wheel on a vehicle, said switch assembly comprising:
at least one switch located on a steering wheel in a vehicle and having a switch output indicative of an actuated position of the switch;
an output terminal for electrically connecting one or more devices to be controlled to the vehicle; and
switch translation circuitry receiving the switch output and translating the switch output to control the one or more devices based on the actuated switch position.

13. The switch assembly as defined in claim 12, wherein the switch assembly comprises a plurality of switches located on the steering wheel for controlling a plurality of devices that are configurable by a user, wherein the translation circuitry determines which actuatable position of a switch is depressed and controls one or more of the devices based on the actuated switch position.

14. The switch assembly as defined in claim 12, wherein the switch assembly is configurable by an upfitter to outfit the vehicle for a user as a specialty vehicle.

15. The switch assembly as defined in claim 12, wherein the translation circuitry performs a diagnostic routine to determine whether the switch is working properly and, if not, provides an output indicator.

16. The switch assembly as defined in claim 12, wherein the controls further comprise one or more indicator lights for indicating the status of the at least one switch.

17. The switch assembly as defined in claim 12 further comprising a resistive network coupled to the at least one switch for generating a voltage indicative of the actuated position of the switch, wherein the switch translation circuitry translates the switch output voltage to determine the actuated switch position based on the voltage.

18. The switch assembly as defined in claim 12, wherein the switch translation circuitry translates the switch output to determine the actuated switch position based on a communication message.

19. The switch assembly as defined in claim 12, wherein the switch translation circuitry determines if the switch has been actuated and provides a grounded output to the output terminal to control the device.

20. The switch assembly as defined in claim 12, wherein the switch translation circuitry determines if the switch has been actuated and provides a voltage output to control the device.

21. The switch assembly as defined in claim 12, wherein the at least one switch comprises a plurality of switches, each switch having at least one actuatable position, wherein the translation circuitry translates the switch output to control at least one of a plurality of devices based on the determined actuated position of a switch.
